(19) United States
(12) Patent Application Publication
(10) Pub. No.: US 2013/0143087 A1
(43) Pub. Date: Jun. 6, 2013

(54) CORE/SHELL STRUCTURED ELECTRODES FOR ENERGY STORAGE DEVICES

(71) Applicants: Han Liu, Lutherville-Timonium, MD (US); Corey Adam Fleischer, Columbia, MD (US); Lawrence P. Hetzel, Fallston, MD (US); William Patrick Burgess, Finksburg, MD (US); Gregory F. Pensero, Abingdon, MD (US); Tushar K. Shah, Fulton, MD (US)

(72) Inventors: Han Liu, Lutherville-Timonium, MD (US); Corey Adam Fleischer, Columbia, MD (US); Lawrence P. Hetzel, Fallston, MD (US); William Patrick Burgess, Finksburg, MD (US); Gregory F. Pensero, Abingdon, MD (US); Tushar K. Shah, Fulton, MD (US)

(73) Assignee: APPLIED NANOSTRUCTURED SOLUTIONS, LLC., Baltimore, MD (US)

(21) Appl. No.: 13/309,492

(22) Filed: Dec. 1, 2011

(51) Int. Cl. H01M 10/36; H01M 10/02; H01M 10/04; H01G 9/155; H01M 4/62; H01M 10/0562; B82Y 99/00

(52) U.S. Cl. 429/94; 429/232; 429/152; 429/304; 29/746; 361/502; 977/948; 180/65.21; 903/907

(57) ABSTRACT

An energy storage device can include at least one electrode that comprise a plurality carbon nanostructure (CNS)-infused fibers in contact with an active material and an electrolyte.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention generally relates to carbon nanostructures in electrodes, and, more specifically, in core/shell electrode structures.

### BACKGROUND

Energy storage devices are widely used in every aspects of our economy. By way of nonlimiting examples, low-capacity batteries are used as the power supply for small electronic devices, such as cellular telephones, notebook computers, and camcorders, while the high-capacity batteries are used as the power supply for driving motors in hybrid electric vehicles and the like. Recently, grid scale energy storage for renewable energy sources also needs large quantity of energy be stored and delivered quickly. As the devices used in conjunction with electrochemical energy storage devices become more complex with greater electrical demand, the energy storage device characteristics must improve.

Energy storage devices can be characterized by their cycling lifetime and their charge-discharge rates. These characteristics are primarily influenced by the positive and negative electrodes of the energy storage device. Generally, an electrode of an energy storage device includes an active material and a current collector. The active material undergoes a chemical reaction, e.g., reduction or oxidation of ions, during charging and discharging while the current collector transmits electrons between the active material and its respective terminal. Further, an electrolyte that mediates transfer of ions, e.g., lithium ions, between the positive electrode and the negative electrode.

The composition and configuration of the active material and the current collector affect the characteristics of the electrode. Charge and discharge rates of energy storage devices depend on, among other things, the electrical resistance and ion diffusion rate of the electrodes. Many high capacity electrode materials, such as LiFePO₄, V₂O₅, have high resistance and low ion diffusion rates. Nanoparticles of the electrode material have been incorporated into the electrode to mitigate the problem. The electrodes are usually prepared by mixing nanoparticles and traditional conductive additives. Nanoparticles act to decrease the ion diffusion path thereby increasing the ion diffusion rate. To ensure the nanoparticles are in good contact with conductive additives, the amount of the additive must be high, which inevitably reduces the specific capacity of the electrode.

As electrodes proceed with the progress of the charging and discharging cycles, the electrodes expand and contract during the absorption and desorption of the ions. The expansion and contraction result in reduction in or loss of contacts between the active material and its current collector. These adverse effects result in a significantly shortened cycling lifetime. To overcome the problems associated with such mechanical degradation, several approaches have been proposed, including using nano-scaled particles as active material. However, most of prior art composite electrodes have deficiencies like less than satisfactory reversible capacity, poor cycling stability, high irreversible capacity, and ineffectiveness in reducing the internal stress or strain during the charge/discharge cycles such as lithium ion insertion and extraction cycles.

In view of the foregoing, electrode structures with higher charge-discharge rates and increased cycling lifetime would be of substantial beneficial in the art. The present invention satisfies this need and provides related advantages as well.

### SUMMARY

In general, embodiments disclosed herein relate to carbon nanostructures in core/shell electrode structures for use in energy storage devices.

In certain embodiments, an energy storage device has at least one electrode that includes a plurality carbon nanostructure (CNS)-infused fibers in contact with an active material and an electrolyte.

In certain embodiments, an energy storage device has a plurality of positive electrodes, a plurality of negative electrodes, and an electrolyte. At least one of the positive electrodes and/or at least one of the negative electrodes includes a CNS-infused fiber in contact with an active material.

In certain embodiments, an electrode has a CNS-infused fiber in contact with an active material.

In certain embodiments, a method of producing a core/shell electrode structure includes providing a CNS-infused fiber and applying an active material to the CNS-infused fiber so as to create a plurality of contact points between the active material and the CNS-infused fiber.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1C show nonlimiting examples of the path electrons can travel through the bicontinuous current collectors.

FIG. 2 shows nonlimiting examples of core/shell electrode structures.

FIG. 3 shows a nonlimiting example of an energy storage device having a stacked architecture.

FIG. 4 shows a nonlimiting example of a component of an energy storage device having a rolled architecture.

FIGS. 5A-B show nonlimiting examples of an energy storage device having an intermingled fiber architecture.

FIG. 6 shows a scanning electron micrograph of a CNS-infused carbon fiber.

FIG. 7 shows a scanning electron micrograph of CNS-infused on a carbon fiber.

FIG. 8 shows a scanning electron micrograph of CNS-infused on carbon fiber an active material has been electrodeposited on the CNSs.

### DETAILED DESCRIPTION

The present disclosure is directed, in part, to carbon nanostructures in core/shell electrode structures for energy storage devices.

As used herein, the terms “electrochemical energy storage device” or “energy storage device” refers to a chargeable and dischargeable power storage unit. Nonlimiting examples of electrical storage devices include capacitors, ultracapacitors, supercapacitors, pseudocapacitors, batteries, low-capacity secondary batteries, high-capacity secondary batteries, ultracapacitor-battery hybrids, pseudocapacitor-battery hybrids, and energy storage cells.

As used herein, the term “carbon nanostructures” (CNS, plural CNSs) refers to a structure that is less than about 100 nm in at least one dimension and substantially made of carbon. Carbon nanostructures can include graphene, fullerenes, carbon nanotubes, bamboo-like carbon nanotubes, carbon nanohorns, carbon nanofibers, carbon quantum dots, and the like. Further, CNSs can be present as an entangled and/or interlinked network of CNSs. Interlinked networks can contain CNSs that branch in a dendrimeric fashion from other CNSs. Interlinked networks can also contain bridges between CNSs, by way of nonlimiting example, a carbon nanotube can have a least a portion of a sidewall shared with another carbon nanotube.

As used herein, the term “graphene” will refer to a single- or few-layer (e.g., less than 10 layer) two-dimensional carbon sheet having predominantly sp² hybridized carbons. In the embodiments described herein, use of the term graphene should not be construed to be limited to any particular form of graphene unless otherwise noted.

As used herein, the term “carbon nanotube” will refer to any of a number of cylindrically-shaped allotropes of carbon of the fullerene family including single-walled carbon nanotubes (SWNTs), double-walled carbon nanotubes (DWNTs), and multi-walled carbon nanotubes (MWNTs). Carbon nanotubes can be capped by a fullerene-like structure or open-ended. Carbon nanotubes can include those that encapsulate other materials.

As used herein, the term “substrate” is intended to include any material upon which CNSs can be synthesized and can include, but is not limited to, a carbon fiber, a graphite fiber, a cellulosic fiber, a glass fiber, a metal fiber (e.g., steel, aluminum, etc.), a metallic fiber, a ceramic fiber, a metallic-ceramic fiber, a polymer fiber (e.g., nylon, polyethylene, aramid, etc.), or any substrate comprising a combination thereof. The substrate can include fibers or filaments arranged, for example, in a fiber tow (typically having about 1000 to about 12,000 fibers) as well as planar substrates such as fabrics, tapes, or other fiber broadgoods (e.g., veils, mats, and the like), and materials upon which CNSs can be synthesized.

As used herein, the term “infused” means chemically or physically bonded and “infusion” means the process of bonding. The particular manner in which a CNS is “infused” to a substrate is referred to as a “bonding motif”

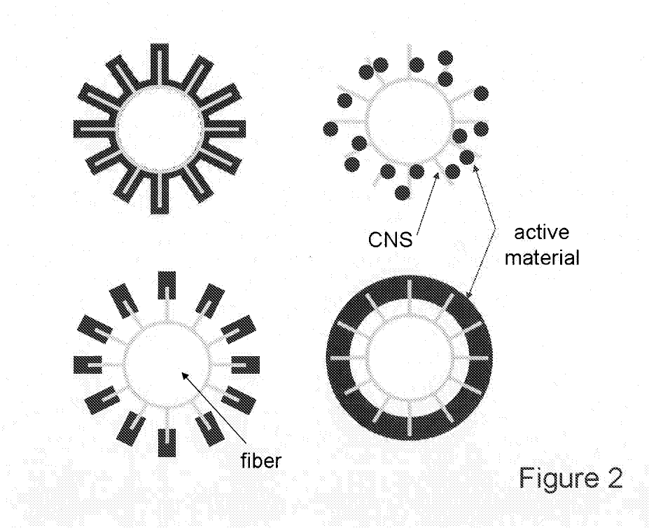

Core/shell electrode structures generally comprise CNS-infused fiber in contact with an active material. Contact can involve a coating, particles intercalated in the CNS of the CNS-infused fibers, particles on the CNS of the CNS-infused fibers, or any combination thereof, nonlimiting examples of which are shown in FIG. 2. Without being bound by theory or mechanism, the CNS-infused fibers act as bicontinuous current collectors of the electrode. The CNS portion of the CNS-infused fibers provide better contact with the active material with increased surface area and higher conductivity. Further, in some embodiments where the CNS portion of the CNS-infused fiber is entangled, the CNS can act to transfer electrons between the active material and its respective terminal. The fiber portion of the CNS-infused fibers provide strength, flexibility, and, in some embodiments, a main conduit for transmitting electrons within the bicontinuous current collectors. The core/shell electrode structures discussed herein advantageously provide higher charge-discharge rates and increased cycling lifetimes while further providing flexibility and mechanical strength which can translate to electrodes with unique structural properties.

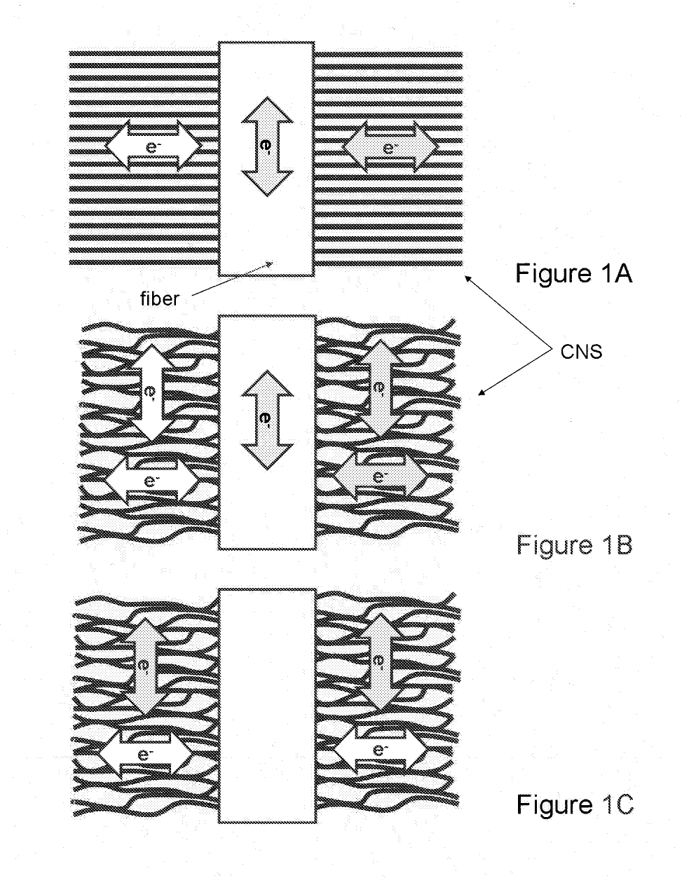

FIGS. 1A-1C show nonlimiting examples of the path electrons can travel through the bicontinuous current collectors. The electron path depends on both the CNS arrangement and the fibers on which the CNSs are infused. CNSs that form a continuous network, as shown in FIGS. 1B and 1C, allow for electrons to pass from CNS to CNS and from CNSs to the fiber. CNSs that form noncontinuous networks, as shown in FIG. 1A, allow for electrons to pass from CNSs to the fiber. In some embodiments, CNS networks may be both continuous and noncontinuous. Fiber materials that are electrically conductive, e.g., copper or aluminum, allow for electrons to pass along the longitudinal axis of the fiber, as shown in FIGS. 1A and 1B. Fiber materials that are insulating, e.g., glass, prevent substantial electron flow along the longitudinal direction of the fiber, as shown in FIG. 1C. In such embodiments, electron flow would be through a continuous or substantially continuous CNS network, as shown in FIG. 1C.

Examples and production methods of CNS-infused fibers can be found in U.S. Patent Application Publication Numbers 2010/0159240 entitled “CNT-Infused Metal Fiber Materials and Process Thereof,” 2010/0178825 entitled “CNT-Infused Carbon Fiber Materials and Process Thereof,” and 2011/0171469 entitled “CNT-Infused Aramid Fiber Materials and Process Thereof” and U.S. patent application Ser. No. 12/611,103 entitled “CNT-Infused Ceramic Fiber Materials and Process Thereof,” the entire disclosures of which are herein incorporated by reference. In some embodiments, CNSs of the CNS-infused fibers are aligned radially from the fiber longitudinal axis. It should be noted that the term “radially” does not imply a 90° deviation from the longitudinal axis of the fiber for all CNSs, rather an orientation the extends outward from the fiber rather than aligned with the longitudinal axis of the fiber.

The properties of the CNSs can impact the properties of the bicontinuous current collectors. In some embodiments, CNS can extend from the fiber surface about 100 nm or greater, about 500 nm or greater, about 1 micron or greater, about 5 microns or greater, or about 50 microns or greater. One skilled in the art, with the benefit of this disclosure, would understand that CNSs that extend farther from the fiber surface can be beneficial with an upper limit being in excess of about 100 microns. In some embodiments, CNSs can include CNTs. While smaller diameter CNTs are preferable, diameters in excess of about 100 nm are acceptable.

The amount of CNS-infused to the fiber can also impact the properties of the bicontinuous current collectors. In some embodiments, the density of CNSs on the fiber surface, or percent of fiber surface covered (in direct contact) with CNSs, can range from about 1% to about 95%. In some embodiments, the CNS-infused fiber can have CNS in an amount ranging from about 1% to about 80% by weight of CNS to fiber.

Fibers suitable for infusion can include, but not be limited to, carbon fibers, glass fibers, metal fibers, ceramic fibers, polymer (e.g., aramid) fibers, ceramic on glass, or any combination thereof. Examples of a carbon fiber material include, but are not limited to, a carbon filament, a carbon fiber yarn, a carbon fiber tow, a carbon tape, a carbon fiber-braid, a woven carbon fabric, a non-woven carbon fiber mat, a carbon fiber ply, and other 3D woven structures.

In some aspects of the disclosure, a number of primary fiber material structures can be organized into fabric or sheet-like structures. These include, for example, woven carbon fabrics, non-woven carbon fiber mat and carbon fiber ply, and tapes. Such higher ordered structures can be assembled from parent tows, yarns, filaments or the like, with or without CNSs already infused in the parent fiber.

Positive electrode active materials can include, but not be limited to, pure elements (sulfur), organic compounds and/or inorganic compounds like transition metal oxides, complex oxides of lithium and transition metals, metal sulfite, phosphate, sulfate or any combination thereof. Suitable organic compounds can include, but not be limited to, polyaniline, polypyrrole, polyacene, disulfide system compound, polysulfide system compound, N-fluoropyridinium salt, or any combination thereof. Suitable transition metal oxides can include, but not be limited to, oxides of Li, Fe, Co, Ni, Ru and Mn (e.g., MnOₓ, V₂O₅, V₆O₁₃, V₂O₅, RuOₓ, TiO₂); or any combination thereof. Suitable complex oxides of lithium and transition metals can include, but not be limited to, lithium nickelate, lithium cobaltate, lithium manganate, LiCoO₂ LiNiO₂, LiMnO₃, LiMn₂O₃, LiMnO₂, LiV₃O₈, LiFe₃O₄, Cu₂V₂O₇, LiNi₁₋ₓMₓO₂ (where, M=Co, Mn, Al, Cu, Fe, Mg, B, or Ga, and x=0.01 to 0.3), LiMn₂₋ₓMₓO₂ (where, M=Co, Ni, Fe, Cr, Zn, or Ta, and x=0.01 to 0.1), Li₂Mn₃MO₈ (where, M=Fe, Co, Ni, Cu, or Zn), LiFePO₄, AgₓNi_{Y}O (wherein X/Y is smaller than 1 and not smaller than 0.25), or any combination thereof. Suitable metal sulfides can include, but not be limited to, TiIS₂, FeS, MoS₂, Li₂S, or any combination thereof.

Negative electrode active materials can include, but not be limited to, pure elements with minimal impurities (e.g., carbons, silicon, and germanium), carbon mixtures, conductive polymers oxides, sulfates, or any combination thereof. Suitable carbons can include, but not be limited to, graphite and coke. Suitable carbon mixtures can include, but not be limited to, carbons mixed with metals, metallic salts, oxides, or any combination thereof. Suitable conductive polymers can include, but not be limited to, polyacetylene. Suitable oxides and sulfates can include, but not be limited to, oxides and sulfates of silicon, tin, zinc, manganese, iron, nickel, vanadium, antimony, lead, germanium, and/or lithium (e.g., SnO, SiSnO₃, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, Bi₂O₅, LiNiVO₄, LiCoVO₄, LiNiO₂, Li_{0.95}NiO_{z}, LiNi_{0.9}Co_{0.1}O_{z}, LiNi_{0.98}V_{0.02}O_{z}, LiNi_{0.9}Fe_{0.1}O_{z}, LiNi_{0.95}Mn_{0.05}O_{z}, LiNi_{0.97}Ti_{0.03}O_{z}, LiNi_{0.97}Cu_{0.030}O_{z}, LiMn₂O₄, Li_{0.95}Mn₂O_{z}, LiMn_{1.8}Co_{0.1}O_{z}, LiMn_{0.9}Fe_{0.1}O_{z}, LiMn_{0.97}Ti_{0.03}O_{z}, and LiMn_{0.97}Cu_{0.03}O_{z}, wherein z is from 1.7 to 2.3); lithium transition metal nitride; calcined carbonaceous materials; spinel compounds (e.g., TiS₂, LiTiS₂, WO₂, and LiₓFe(Fe₂O₄) wherein x is from 0.7 to 1.3); lithium compounds of Fe₂O₃; Nb₂O₅; iron oxides (e.g., FeO, Fe₂O₃, and Fe₃O₄); cobalt oxides (e.g., CoO, Co₂O₃, and Co₃O₄); and the like; or any combination thereof.

Forming contact between the CNS-infused fibers and active material can include coating CNS-infused fibers with active materials. As used herein, the term “coating,” and the like, does not imply any particular degree of coating. In particular, the terms “coat” or “coating” do not imply 100% coverage by the coating. In some embodiments, coatings can be greater than about 1 nm. One skilled in the art, with the benefit of this disclosure, would understand that the coating thickness can be to any operable upper limit which depends on the active material and the characteristics of the CNS-infused fibers. Further, one skilled in the art would understand that while excessively thick coatings may be operable, they may reduce the benefits of the core/shell electrode structures discussed herein. In some embodiments, coatings can be of thicknesses ranging from about 1 nm to about 10 microns, about 1 nm to about 1 micron, about 10 nm to about 1 micron, or about 1 nm to about 100 nm.

Forming contact between the CNS-infused fibers and active material can include particles on the CNSs and/or intercalated within the CNS network. Particles of active materials can be of any shape including, but not limited to, spherical and/or ovular, substantially spherical and/or ovular, discus and/or platelet, flake, ligamental, acicular, fibrous, polygonal (such as cubic), randomly shaped (such as the shape of crushed rocks), faceted (such as the shape of crystals), or any hybrid thereof. Particles can have a size with at least one dimension ranging from about 1 nm to about 100 microns, 1 nm to about 10 microns, about 1 nm to about 1 micron, about 10 nm to about 1 micron, or about 1 nm to about 100 nm. Particles can be a mixture of particles having different compositions, sizes, shapes, microstructures, crystal structures, or any combination thereof.

Contact between CNS-infused fibers and active materials (coatings and/or particles) can be achieved by dip coating, painting, washing, spraying, aerosolizing, sputtering, chemical reaction based deposition, electrochemical depositing, chemical vapor deposition, physical vapor deposition or any combination thereof. In some embodiments, coatings may be applied during production of the CNS-infused fibers. In some embodiments, coatings may be applied in post-production methods. In some embodiments, active materials can be applied in the form of particles, as a fluid, in a suspension, as precursors in a suspension, or any combination thereof. It should be noted that the term “suspension” includes solutions.

In some embodiments, the active materials may have a high surface area in contact with the electrolyte. In some embodiments, the surface area can range from about 0.1 m²/g to about 500 m²/g, about 1 m²/g to about 500 m²/g, about 10 m²/g to about 500 m²/g, or about 10 m²/g to about 250 m²/g.

Active materials can have several spatial arrangements relative to the CNS-infused fiber, e.g., periodically along the longitudinal axis of the fiber, more than one active material in alternating coatings along the axis of the fiber, more than one coating on the CNS-infused fiber (including multiple coatings on only portions of the CNS-infused fiber), at the ends of the CNSs distal to the fiber, intercalated between CNSs, intercalated between CNSs through to the surface of the fiber, or any combination thereof.

In some embodiments, CNSs may be functionalized to enhance contact between the active material and the CNSs. Some embodiments can involve covalent functionalization and/or non-covalent functionalization, e.g., pi-stacking, physisorption, ionic association, van der Waals association, and the like. Suitable functional groups may include, but not be limited to, moieties comprising amines (1°, 2°, or 3°), amides, carboxylic acids, aldehydes, ketones, ethers, esters, peroxides, silyls, organosilanes, hydrocarbons, aromatic hydrocarbons, or any combination thereof; polymers; chelating agents like ethylenediamine tetraacetate, diethylenetriaminepentaacetic acid, triglycollamic acid, and a structure comprising a pyrrole ring; or any combination thereof. One skilled in the art would understand that functionalization can decrease the conductivity of CNSs, and therefore, the degree of functionalization should provide the necessary enhancement in contact between the CNSs and the active material while maintaining necessary conductivity of the CNSs.

While the core/shell electrode structures describe herein can be used to form standard electrodes configurations, e.g., rods and discs, the core/shell electrode structures are advantageously flexible while being mechanically strong which provides for electrodes with woven or nonwoven fabric configurations, wound configurations, tape configurations, and the like. Electrode configurations can be individual core/shell electrode structures; a plurality of core/shell electrode structures that are aligned, wound, woven, braided, matted, and the like, or any combination thereof; or individual or a plurality of core/shell electrode structures in conjunction known electrodes.

In some embodiments, core/shell electrodes comprising CNS-infused fiber in contact with an active material can be included in an energy storage device. Generally, an energy storage device can include positive electrodes, negative electrodes, and electrolytes therebetween. Energy storage devices can further include a positive terminal connected to the positive electrodes and a negative terminal connected to the negative electrodes. Energy storage devices can further include a separator in the electrolyte to assist in the flow of ions between the positive electrodes and the negative electrodes.

Electrolytes may be in the form of solids, liquids (aqueous and/or nonaqueous), pastes, and the like. Suitable electrolytes can comprise salts like borate salts lithium salts, sodium salts, magnesium salts, iron salts, and bismuth salts (e.g., LiClO₄, LiBF₄, LiPF₆, LiCF₃SO₃, LiC₄F₉SO₃, LiN(CF₃SO₂), LiCF₃CO₂, LiAsF₆, LiSbF₆, LiB₁₀Cl₁₀, Li(1,2-dimethoxyethane)₂ClO₄, lower fatty acid lithium salts, LiAlO₄, LiAlCl₄, LiCl, LiBr, LiI, chloroboran lithium, lithium tetraphenylborate, BiSO₄HSO₄); solid electrolytes containing lithium compounds like Li₃PO₄, Li₄SiO₄, and Li₂SO₄; polyethylene oxide added to any of the foregoing salts; organic solid electrolytes like polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups; any derivative thereof; and the like; or any combination thereof. By way of nonlimiting examples, nonaqueous liquids may be an electrolyte in an aprotic organic solvent including, but not limited to, ethylene carbonate, propylene carbonate, butylene carbonate, dimethyl carbonate, ethylmethyl carbonate, diethyl carbonate, methyl propionate, ethyl propionate, γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, ionic liquids (e.g. methylimidazolium tetrafluoroborate), any aprotic derivative thereof, and any mixture thereof.

Separators can have a pore diameter of about 0.01 to about 10 microns and a thickness of about 5 microns to about 300 microns. Separators can be sheets or non-woven fabrics made of an olefin polymer, such as polypropylene, cellulose and modified cellulose, polyimides, glass fibers or polyethylene, or any combination thereof, which has chemical resistance and hydrophobicity. When a solid electrolyte, such as a polymer, is employed, the solid electrolyte can also serve as both the separator and the electrolyte, which may include, but not be limited to, poly(ethylene oxide), poly(vinylidene fluoride), NAFION® (a sulfonated tetrafluoroethylene based fluoropolymer-copolymer, available from DuPont), sulfonated and phosphonated polymers, or any combination thereof.

In some embodiments, energy storage devices can include core/shell electrodes according to any structure described herein as at least some of the negative electrodes, at least some of the positive electrodes, or any combination thereof. When not included as all electrodes of the energy storage device, any other electrode structure and/or configuration known to one skilled in the art may be used in conjunction with the core/shell electrodes according to any structure and/or configuration described herein. By way of nonlimiting example, other electrode structures can include fabrics, sheets, meshes, fibers, wires, and the like of active materials with thicknesses and/or diameters of about 1 nm to about 10 mm.

Energy storage devices can have any architecture of positive electrodes, negative electrodes, and electrolyte known to one skilled in the arts. By way of nonlimiting example, energy storage devices can have electrodes in a stacked architecture, a rolled architecture, an intermingled fiber architecture, any hybrid thereof, or any combination thereof. Further, energy storage devices can include electrodes in a unipolar and/or bipolar configuration.

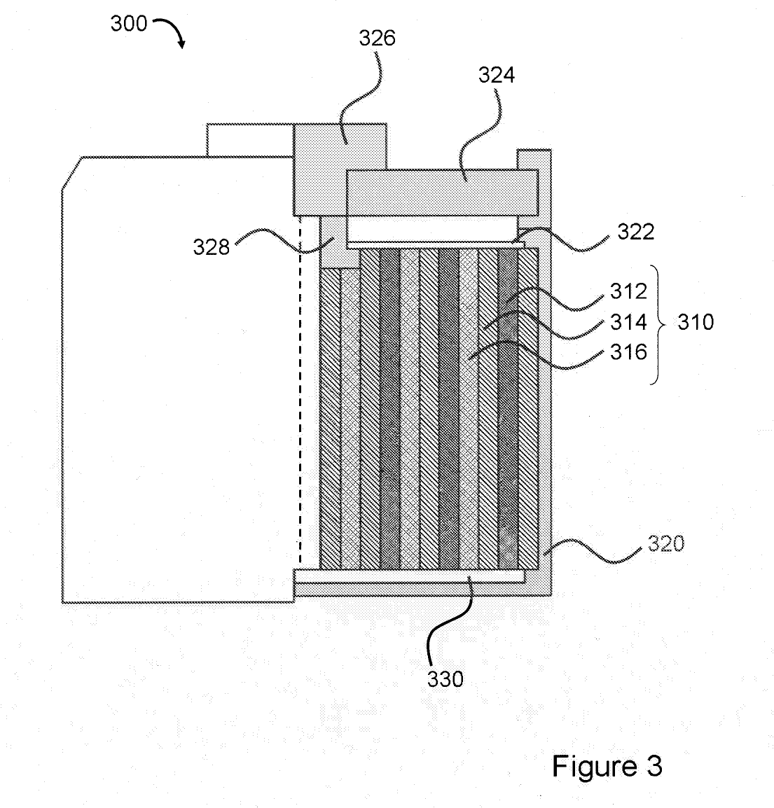

By way of nonlimiting example, FIG. 3 shows energy storage device 300 with a stacked architecture. Case 320 made of metal has, at the bottom thereof, an insulating body 330. Assembly 310 of electrodes is housed in cylindrical case 320 such that a strip-like laminate body, comprising positive electrode 312, separator 314, and negative electrode 316 stacked in this order, is spirally wound with a separator being disposed at the outermost side of the electrode assembly 310. Case 320 is filled with an electrolyte. A sheet of insulating paper 322 having an opening at the center is disposed over electrode assembly 310 placed in case 320. Insulating seal plate 324 is mounted at the upper opening of case 320 and hermetically fixed to case 320 by caulking the upper opening portion of case 320 inwardly. Positive electrode terminal 326 is fitted in the central opening of insulating seal plate 324. One end of positive electrode lead 328 is connected to positive electrode 312 and the other end thereof is connected to positive electrode terminal 326. Negative electrode 316 is connected via a negative lead (not shown) to case 320 functioning as a negative terminal.

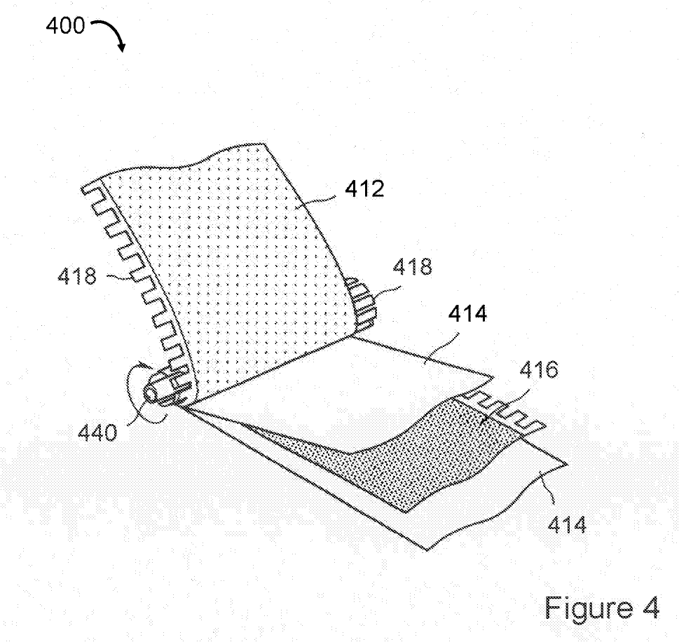

By way of nonlimiting example, FIG. 4 shows a portion of an energy storage device with a rolled architecture. Positive electrode 412, the negative electrode 416, and the separators 414 are rolled in the order of the positive electrode 412, the separator 414, the negative electrode 416, and the separator 414, and wound on the spindle 440, thereby forming energy storage device 400. At this time, in rolled architecture 400, the positive electrode 412 and the negative electrode 416 are wound such that the stripe-like leads 418 of the positive electrode 412 are gathered on one side of rolled architecture 400 and the stripe-like leads 418 of the negative electrode 416 are gathered on the other side of rolled architecture 400. To form an energy storage device, rolled architecture 400 can be placed in a housing containing an electrolyte solution and properly connected to positive and negative terminals.

An intermingled fiber architecture generally includes a plurality of elongated electrodes with an intermingling between the positive and negative electrodes. Intermingled fiber architectures can include, but not be limited to, wound electrodes, interwoven electrodes (either with a desired pattern or randomly), interlaced electrodes, alternating electrodes, and the like. In some embodiments, all or some of the positive electrodes can be core/shell electrode structures. In some embodiments, all or some of the negative electrodes can be core/shell electrode structures.

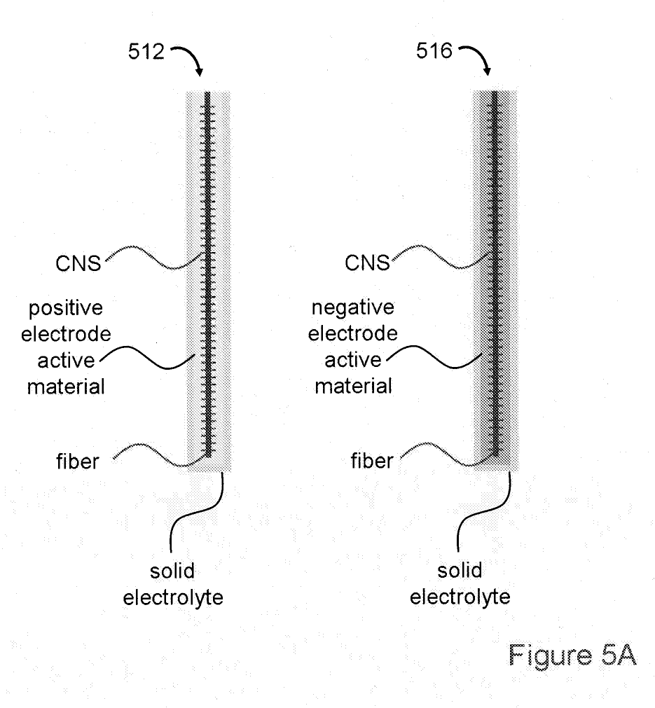

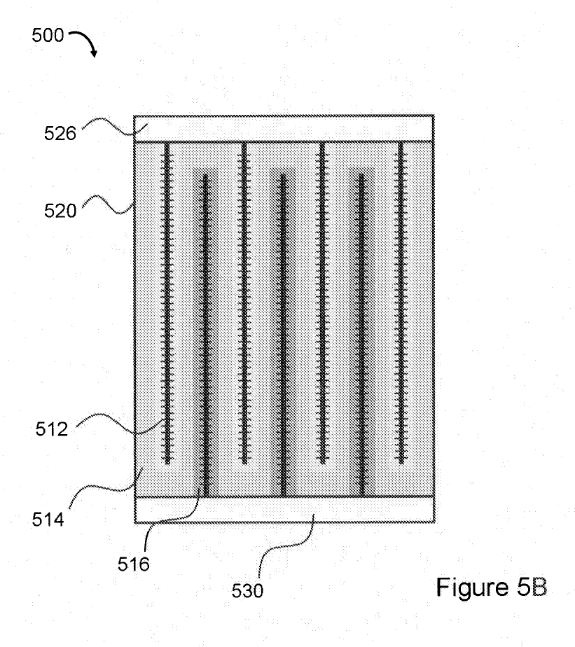

By way of nonlimiting example, FIG. 5B shows an energy storage device 500 with an intermingled fiber architecture having alternating electrodes. FIG. 5A shows the structure of positive electrode 512 and negative electrode 516 with a coating of a solid electrolyte 514. Said electrodes can be attached to a corresponding positive electrode terminal 526 and negative electrode terminal 530. The electrode/electrode terminal pairs can then be integrated into energy storage device 500 with case 520 and additional solid electrolyte 514 as needed. Additional components can be integrated as needed and known to one skilled in the art. Further, one skilled in the art would recognize that either of the electrodes depicted in FIG. 5B can be interchanged with an electrode not comprising a core/shell electrode configuration.

In some embodiments, energy storage devices according to any embodiments disclosed herein can be a component of another device and/or operably connected to another device including, but not limited to, sensors, small electronic devices, cellular telephones, notebook computers, cameras, camcorders, audio players, hybrid electric vehicles, electric grids, and the like. In some embodiments, energy storage devices according to any embodiments disclosed herein can be operably connected energy production and/or harvesting devices including, but not limited to, photovoltaics, wind turbines, fuel cells, flow batteries, and the like.

It should be noted that while some embodiments of the present application are directed toward energy storage devices that are rechargeable and dischargeable for several cycles, the electrodes, electrode configurations, energy storage device architectures, and the like may be adapted to primary storage devices like one-time use batteries.

In some embodiments, an energy storage device can include at least one electrode that comprise a plurality CNS-infused fibers in contact with an active material and an electrolyte.

In some embodiments, an energy storage device can include a plurality of positive electrodes, a plurality of negative electrodes, and an electrolyte. At least one of the positive electrodes and/or at least one of the negative electrodes can include a CNS-infused fiber in contact with an active material.

In some embodiments, an electrode can include a CNS-infused fiber in contact with an active material.

In some embodiments, a method of producing a core/shell electrode structure can include applying an active material to a CNS-infused fiber so as to create a plurality of contact points between the active material and the CNS-infused fiber.

It is understood that modifications which do not substantially affect the activity of the various embodiments of this invention are also included within the definition of the invention provided herein. Accordingly, the following Examples are intended to illustrate but not limit the present invention.

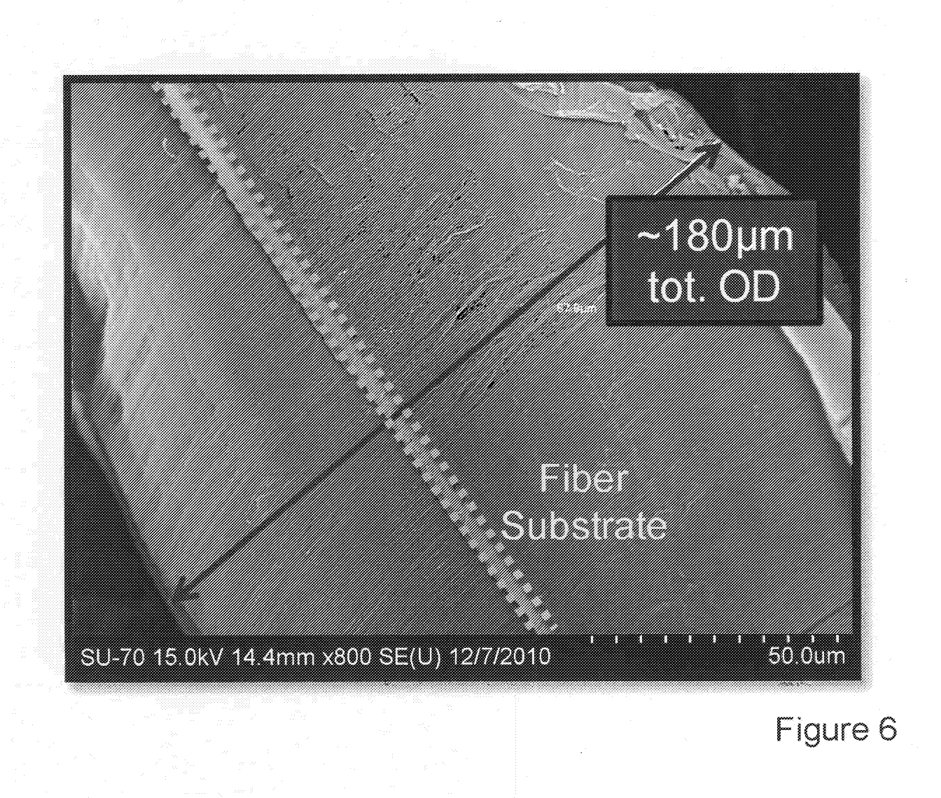

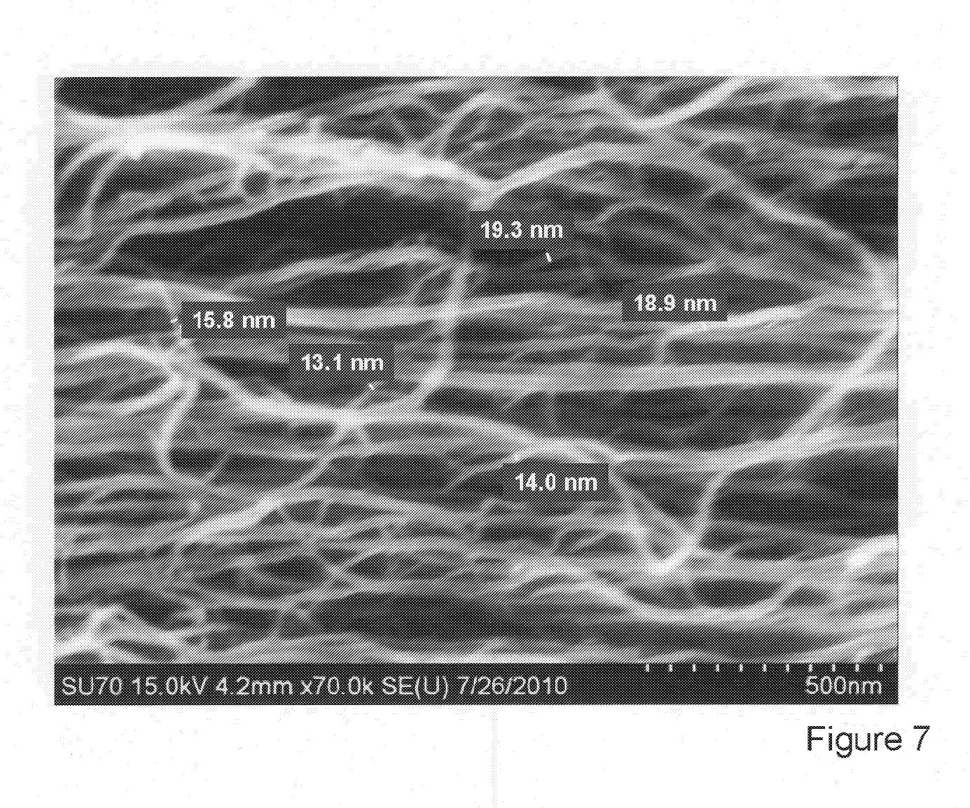

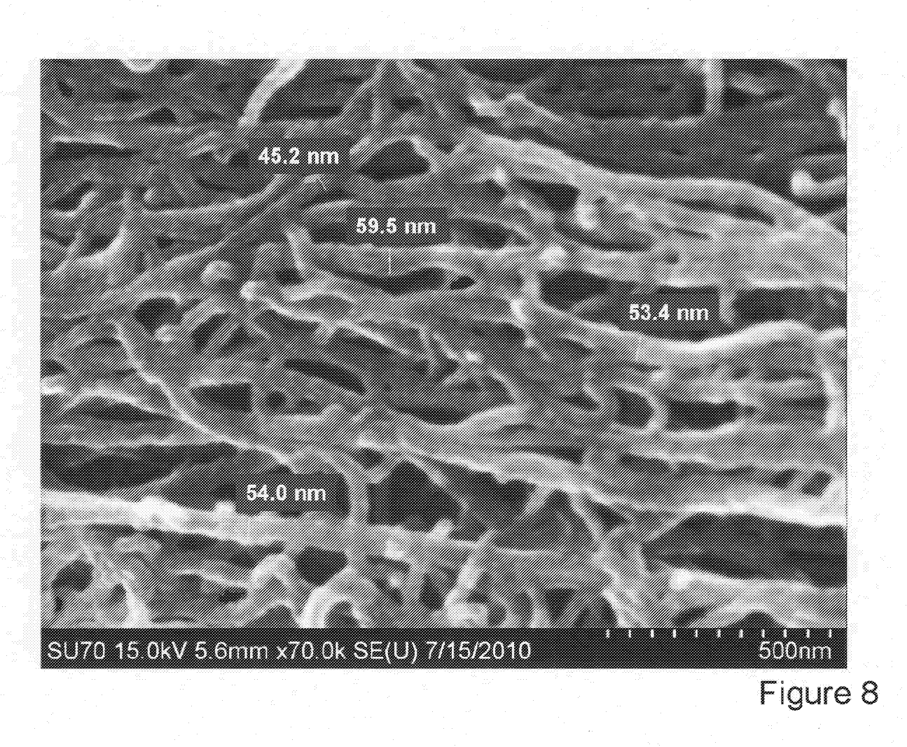

Example 1 investigated the deposition of polypyrrole on a CNS-infused carbon fiber. A CNS-infused carbon fiber was continuously fed into a deposition bath containing 0.05 M pyrrole with KCl as the supporting electrolyte. As the CNS-infused fiber was passed through the deposition bath, a positive potential was applied to the tow against a counter electrode thereby causing the pyrrole to polymerize on the surface of the CNSs. After the deposition bath, the CNS-infused fiber was rinsed to remove excess pyrrole and salt, then dried, and finally would onto a collecting spool. FIGS. 6 and 7 are scanning electron micrographs of the CNS-infused carbon fiber before polypyrrole deposition. The CNS-infused carbon fiber has an outer diameter of about 180 microns with the CNSs including carbon nanotubes having primarily sub-50 micron diameters. FIG. 8 is a scanning electron micrograph of the CNS-infused carbon fiber after polypyrrole deposition. In this example, the polypyrrole deposited on the CNSs, as evidenced by both the diameter increase and morphology change, while maintaining a structure that resembles the structure of the CNSs before polypyrrole deposition. Such a structure may be advantageous in that the surface area of the active material may be higher than a sheet or solid electrode of the same material.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other processes, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is the following:

1. An energy storage device comprising:
at least one electrode that comprises a plurality carbon nanostructure (CNS)-infused fibers in contact with an active material; and
an electrolyte.

2. The energy storage device of claim 1, wherein the CNS-infused fibers comprises at least one selected from the group consisting of: a carbon fiber, a metal fiber, a ceramic fiber, a glass fiber, an organic fiber, a ceramic on glass fiber, and any combination thereof.

3. The energy storage device of claim 1, wherein the CNS-infused fibers comprises a plurality of CNSs that extend radially from a fiber.

4. The energy storage device of claim 1, wherein at least some of the CNS-infused fibers are configured to be at least one selected from the group consisting of: aligned, wound, woven, braided, matted, and any combination thereof.

5. The energy storage device of claim 1, wherein the active material is a shell that substantially coats an individual CNS-infused fiber.

6. The energy storage device of claim 1, wherein the active material is a plurality of particulates in contact with an individual CNS-infused fiber.

7. The energy storage device of claim 1, wherein the at least one electrode is at least one positive electrode that comprises a first plurality carbon nanostructure (CNS)-infused fibers in contact with a first active material and at least one negative electrode that comprises a second plurality carbon nanostructure (CNS)-infused fibers in contact with a second active material.

8. The energy storage device of claim 1, further comprising a positive electrode and wherein the at least one electrode is a negative electrode.

9. The energy storage device of claim 1, further comprising a negative electrode and wherein the at least one electrode is a positive electrode.

10. The energy storage device of claim 1, wherein the plurality of electrodes are configured in a stacked architecture.

11. The energy storage device of claim 1, wherein the plurality of electrodes are configured in a rolled architecture.

12. The energy storage device of claim 1 further comprising:
a separator.

13. The energy storage device of claim 1, wherein the electrolyte is a solid electrolyte.

14. The energy storage device of claim 1, wherein the energy storage device is selected from the group consisting of: a capacitor, an ultracapacitor, a pseudocapacitor, a battery, a low-capacity secondary battery, a high-capacity secondary battery, an ultracapacitor-battery hybrid, a pseudocapacitor-battery hybrid, and an energy storage cell.

15. The energy storage device of claim 1, wherein the energy storage device is operably connected to at least one selected from the group consisting of: a photovoltaic, a wind turbine, and a fuel cell.

16. A device comprising the energy storage device according to claim 1.

17. The device of claim 16, wherein the device is selected from the group consisting of: a sensor, a small electronic device, a cellular telephone, a notebook computer, a camera, a camcorder, an audio player, and a hybrid electric vehicle.

18. An energy storage device comprising:
a plurality of positive electrodes;
a plurality of negative electrodes; and
an electrolyte,
wherein at least one of the positive electrodes and/or at least one of the negative electrodes comprises a carbon nanostructure (CNS)-infused fiber in contact with an active material.

19. The energy storage device of claim 18, wherein the CNS-infused fiber comprises at least one selected from the group consisting of: a carbon fiber, a metal fiber, a ceramic fiber, a glass fiber, an organic fiber, a ceramic on glass fiber, and any combination thereof.

20. The energy storage device of claim 18, wherein the CNS-infused fiber comprises a plurality of CNSs that extend radially from a fiber.

21. The energy storage device of claim 18, wherein the CNS-infused fiber is a plurality of CNS-infused fibers that are configured to be at least one selected from the group consisting of: aligned, wound, woven, braided, matted, and any combination thereof.

22. The energy storage device of claim 18, wherein the active material is a shell that substantially coats the CNS-infused fiber.

23. The energy storage device of claim 18 further comprising:
a separator.

24. The energy storage device of claim 18, wherein the electrolyte is a solid electrolyte.

25. The energy storage device of claim 18, wherein the energy storage device is selected from the group consisting of: a capacitor, an ultracapacitor, a pseudocapacitor, a battery, a low-capacity secondary battery, a high-capacity secondary battery, an ultracapacitor-battery hybrid, a pseudocapacitor-battery hybrid, and an energy storage cell.

26. The energy storage device of claim 18, wherein the energy storage device is operably connected to at least one selected from the group consisting of: a photovoltaic, a wind turbine, and a fuel cell.

27. A device comprising the energy storage device according to claim 18.

28. The device of claim 27, wherein the device is selected from the group consisting of: a sensor, a small electronic device, a cellular telephone, a notebook computer, a camera, a camcorder, an audio player, and a hybrid electric vehicle.

29. An electrode comprising:
a carbon nanostructure (CNS)-infused fiber in contact with an active material.

30. The electrode of claim 29, wherein the CNS-infused fiber comprises at least one selected from the group consisting of: a carbon fiber, a metal fiber, a ceramic fiber, a glass fiber, an organic fiber, a ceramic on glass fiber, and any combination thereof.

31. The electrode of claim 29, wherein the CNS-infused fiber comprises a plurality of CNSs that extend radially from a fiber.

32. The electrode of claim 29, wherein the CNS-infused fiber is a plurality of CNS-infused fibers that are configured to be at least one selected from the group consisting of: aligned, wound, woven, braided, matted, and any combination thereof.

33. The electrode of claim 29, wherein the active material is a shell that substantially coats the CNS-infused fiber.

34. A method of producing a core/shell electrode structure, the method comprising:
applying an active material to a carbon nanostructure (CNS)-infused fiber so as to create a plurality of contact points between the active material and the CNS-infused fiber.

35. The method of claim 34, wherein applying involves at least one selected from the group consisting of: dip coating, painting, washing, spraying, aerosolizing, sputtering, electrochemical depositing, and any combination thereof.

36. The method of claim 34, wherein the active material is in a form selected from the group consisting of: a plurality of particles, a fluid, in suspension, as precursors in a suspension, and any combination thereof.
